(19) United States
(12) Patent Application Publication
(10) Pub. No.: US 2013/0057061 A1
(43) Pub. Date: Mar. 7, 2013

(54) POWER CONVERSION APPARATUS

(71) Applicants: Kazutoshi SHIOMI, Kariya-shi (JP); Masakazu TAGO, Aisai-shi (JP); Atsuyuki HIRUMA, Kariya-shi (JP)

(72) Inventors: Kazutoshi SHIOMI, Kariya-shi (JP); Masakazu TAGO, Aisai-shi (JP); Atsuyuki HIRUMA, Kariya-shi (JP)

(73) Assignee: DENSO CORPORATION, Kariya-city (JP)

(21) Appl. No.: 13/604,648

(22) Filed: Sep. 6, 2012

(30) Foreign Application Priority Data
Sep. 7, 2011 (JP) 2011-195311

(51) Int. Cl. B60R 16/02

(52) U.S. Cl. 307/9.1

(57) ABSTRACT

A power conversion apparatus is provided which includes a plurality of power conversion circuits which individually supply power to a plurality of in-vehicle auxiliary units, a common capacitor which is connected to input terminals of the plurality of power conversion circuits, an operation section which operates respective switching elements of the plurality of power conversion circuits, and a variation section which varies a switching frequency of the switching element configuring at least one of the power conversion circuits, when the operation section turns the switching element on or off. The operation section sets switching frequencies of the switching elements of at least two of the power conversion circuits so as to be different from each other.

### CROSS-REFERENCE TO RELATED APPLICATION

This application is based on and claims the benefit of priority from earlier Japanese Patent Application No. 2011-195311 filed Sep. 7, 2011, the description of which is incorporated herein by reference.

### BACKGROUND

1. Technical Field

The present invention relates to a power conversion apparatus including a plurality of power conversion circuits.

2. Related Art

For example, JP-A-2002-345252 discloses a power conversion apparatus including power conversion circuits (inverters) connected to a plurality of motors. Specifically, this apparatus includes a circuit for each of the inverters. The circuit converts power of an AC power supply to DC power by using a rectifier and a smoothing capacitor.

If providing the circuit including the rectifier and the smoothing capacitor for each of the inverters, the power conversion apparatus becomes larger in size. Hence, when the power conversion apparatus is equipped in a vehicle, it can be difficult to satisfy a constraint of a space for installing the power conversion apparatus.

### SUMMARY

As an aspect of the embodiment, a power conversion apparatus is provided which includes: a plurality of power conversion circuits which individually supply power to a plurality of in-vehicle auxiliary units; a common capacitor which is connected to input terminals of the plurality of power conversion circuits; an operation section which operates respective switching elements of the plurality of power conversion circuits; and a variation section which varies a switching frequency of the switching element configuring at least one of the power conversion circuits, when the operation section turns the switching element on or off. The operation section sets switching frequencies of the switching elements of at least two of the power conversion circuits so as to be different from each other.

### BRIEF DESCRIPTION OF THE DRAWINGS

In the accompanying drawings:

FIG. 1 is a diagram showing a system configuration according to a first embodiment;

FIG. 2 is a time chart showing a method of generating an operation signal according to the first embodiment;

FIGS. 3A and 3B are diagrams showing an object of the first embodiment;

FIG. 4 is a flowchart showing a procedure of a spread spectrum process according to the first embodiment;

FIG. 5 is a diagram showing a method of a spread spectrum process according to a second embodiment; and

FIG. 6 is a diagram showing a method of a spread spectrum process according to a third embodiment.

### DETAILED DESCRIPTION OF THE PREFERRED EMBODIMENTS

With reference to the accompanying drawings, hereinafter are described embodiments. Throughout the drawings, components identical with or similar to each other are given the same numerals for the sake of omitting unnecessary explanation.

### First Embodiment

In the first embodiment, a power conversion apparatus is applied to a hybrid vehicle.

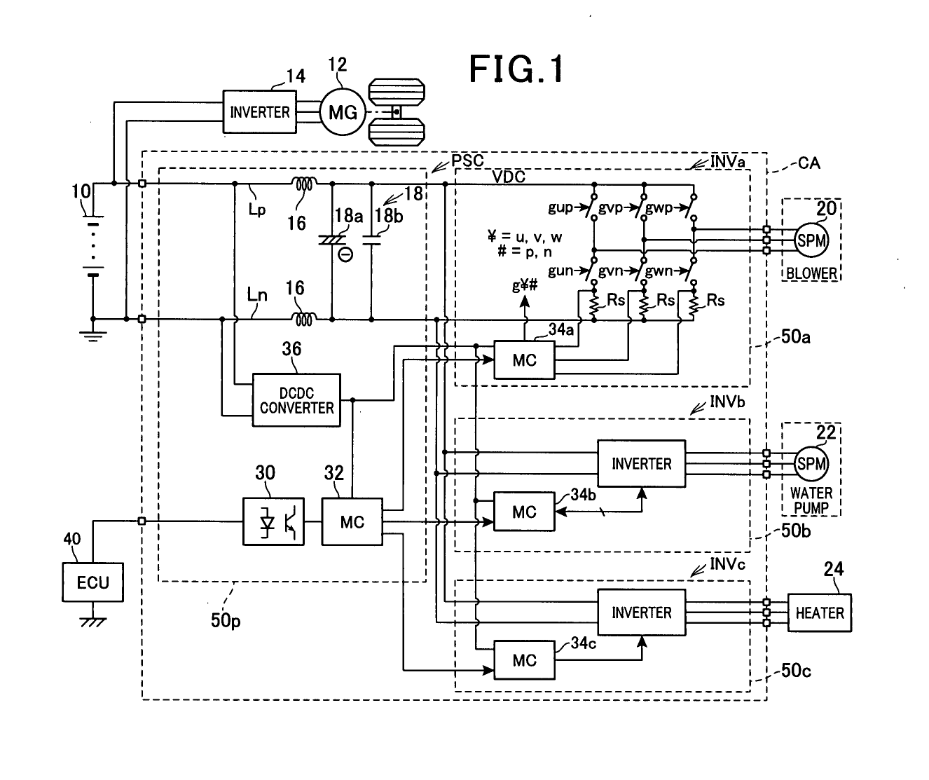

FIG. 1 is a diagram showing a system configuration according to the first embodiment.

A high-voltage battery 10 is a secondary battery whose terminal voltage is, for example, 100 V or more, such as a lithium-ion secondary battery and a nickel-metal hydride battery. The high-voltage battery 10 has a reference potential (negative electrode potential) different from the potential of the body of the vehicle. Specifically, for example, a pair of capacitors is connected to both ends of the, high-voltage battery 10, and the connecting points thereof are connected to the body of the vehicle. Thereby, the middle value between the positive electrode potential and the negative electrode potential of the high-voltage battery 10 becomes equal to the potential of the body of the vehicle.

The high-voltage battery 10 is a power supply of a motor generator 12, which is an in-vehicle traction unit and is connected to the motor generator 12 via an inverter 14. The rotation shaft of the motor generator 12 is mechanically connected to drive wheels.

The high-voltage battery 10 is connected to a pair of power-supply lines Lp, Ln, which is connected to a power supply unit PSC. The power supply unit PSC includes normal mode choke coils 16 respectively connected to the power-supply lines Lp, Ln, and a smoothing capacitor 18. In the present embodiment, the smoothing capacitor 18 includes two types of capacitors 18a, 18b whose frequency characteristics are different from each other. The capacitor 18a is an aluminum electrolytic capacitor. The capacitor 18b is a ceramic capacitor. The capacitor 18b has impedance lower than that of the capacitor 18a in a high frequency band. Hence, noise in a high frequency band is absorbed mainly by the capacitor 18b. Noise in a low frequency band is absorbed mainly by the capacitor 18a.

In the power supply unit PSC, inverters INVa, INVb, INVc are connected in parallel. The inverter INVa applies three-phase AC voltage to a motor 20 of a blower fan installed in an in-vehicle air-conditioning unit. The inverter INVb applies three-phase AC voltage to a motor 22 installed in a water pump which circulates cooling water in cylinder blocks of an in-vehicle internal combustion engine. The inverter INVc applies three-phase AC voltage to a heater 24 installed in the in-vehicle air-conditioning unit. The motors 20, 22 are surface permanent magnet synchronous motors (SPMSM).

As typified by the inverter INVa in FIG. 1, each of the inverters INVa, INVb, INVc is a DC-AC conversion circuit including three series connections of switching elements S [symbol] p, S [symbol] n ( [symbol] =u, v, w). The switching elements S [symbol] p, S [symbol] n connect positive electrodes and negative electrodes of input terminals of the inverters INVa, INVb, INVc (output terminals of the power supply unit PSC) to output terminals of the inverters INVa, INVb, INVc. The switching elements S [symbol] # ( [symbol] =u, v, w; #=p, n) of the inverter INVa are operated by an operation signal g [symbol] # transmitted from a microcomputer (conversion microcomputer 34a). Similarly, the inverters INVb, INVc are operated by the conversion microcomputers 34b, 34c, respectively.

The conversion microcomputers 34a, 34b, 34c are software processing means which include a central processing unit (CPU) and a memory. The CPU performs a program stored in the memory.

As typified by the inverter INVa in FIG. 1, each leg of the inverters INVa and INVb is provided with a shunt resistor Rs. The amount of voltage drop of the shunt resistor Rs is used for detecting the polarity of a line current and the polarity of variation of a line current. The polarity of a line current and the polarity of variation of a line current are parameters controlling controlled variables thereof without a means for detecting angles of rotation of the motors 20, 22. That is, when performing maximum torque and minimum current control, the conversion microcomputers 34a, 34b may set phases of command voltages applied to the motors 20, 22 so that zero cross timing of the line current coincides with zero cross timing of the variation of the line current. Such a technique is disclosed in JP-A-2008-278736.

Note that although the heater 24 is an electric heater, the heater 24 is configured so as to be driven by a three-phase inverter similar to the inverters INVa, INVb.

The conversion microcomputers 34a, 34b, 34c respectively receive command values of controlled variables of the motors 20, 22 and the heater 24 from an electronic control unit (ECU 40) having a reference potential which is the same as the potential of the body of the vehicle. Specifically, the ECU 40 outputs data including information concerning the command values to a communication microcomputer 32 via a photocoupler 30. The communication microcomputer 32 outputs the data including information concerning the command values to the conversion microcomputers 34a, 34b, 34c. The communication microcomputer 32 and the conversion microcomputers 34a, 34b, 34c use a DCDC converter 36 as a power supply. The DCDC converter 36 decreases the voltage of the high-voltage battery 10 and outputs the decreased voltage. Both the communication microcomputer 32 and the conversion microcomputers 34a, 34b, 34c operate at a reference potential (negative electrode potential of the high-voltage battery 10) different from the potential of the body of the vehicle

The communication microcomputer 32 is a software processing means which includes a central processing unit (CPU) and a memory. The CPU performs a program stored in the memory. The photocoupler 30 is an insulation communication means which transmits signals while insulating an in-vehicle high-voltage system including the communication microcomputer 32 from an in-vehicle low-voltage system including the ECU 40, considering the difference between the reference potentials of the communication microcomputer 32 and the ECU 40.

The communication microcomputer 32, the photocoupler 30, the power supply unit PSC, and the DCDC converter 36 are mounted on a power supply board 50p. The inverter INVa and the conversion microcomputer 34a are mounted on a conversion board 50a. The inverter INVb and the conversion microcomputer 34b are mounted on a conversion board 50b. The inverter INVc and the conversion microcomputer 34c are mounted on a conversion board 50c.

The power supply board 50p and the conversion boards 50a, 50b, 50c are accommodated in a single case CA. In-vehicle auxiliary units (the motors 20, 22 and the heater 24) are externally attached to the case CA. This aims to miniaturize the case CA so as to be disposed at a position where the case CA is unlikely to be damaged even in a collision of vehicles.

Note that, conventionally, an auxiliary unit actuator and a control system thereof (a set of the motor 20, the conversion microcomputer 34a, and the inverter INVa, a set of the motor 22, the conversion microcomputer 34b, and the inverter INVb, and the like) have tended to be accommodated in the same case. This is because lower-cost elements such as a hall element are used in general as a means for detecting an angle of rotation of an auxiliary unit motor. In this case, it has been desired to dispose the control system (a conversion microcomputer and an inverter) in the vicinity of the motor. The present embodiment avoids the situation in which the above requirement is caused by the sensorless control described above.

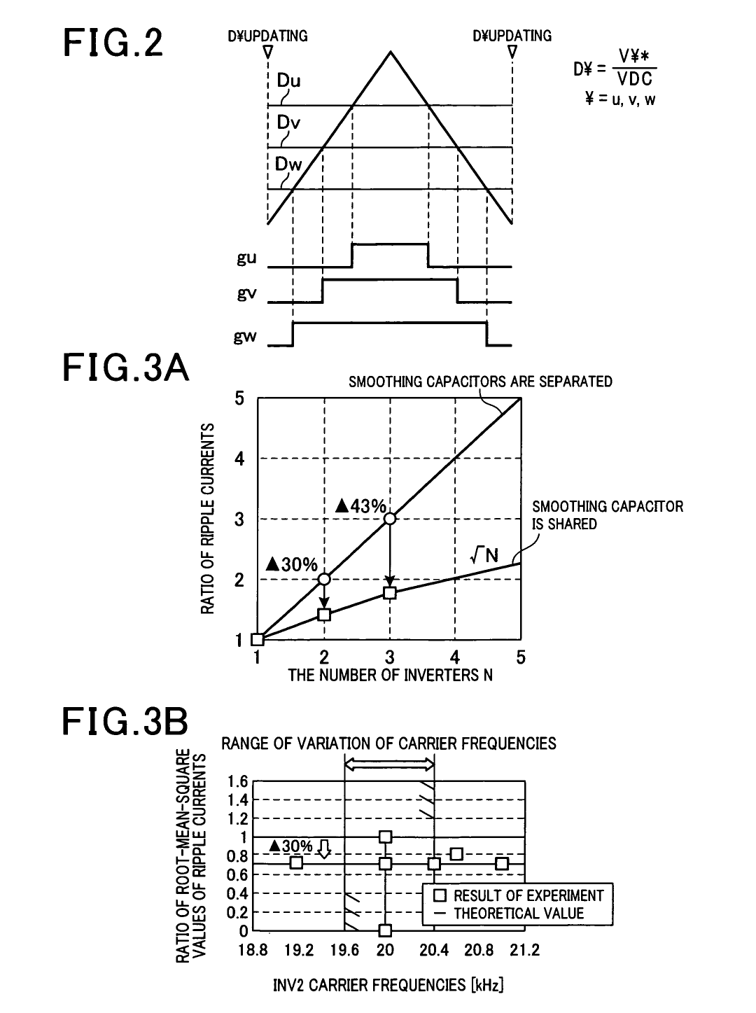

Next, control of controlled variables of auxiliary units by the conversion microcomputers 34a, 34b, 34c according to the present embodiment is described. In the present embodiment, to perform control according the command values outputted from the ECU 40, command voltages (command values of output voltages of the inverters INVa, INVb, INVc) applied to the auxiliary units are operated. This operation is performed, as shown in FIG. 2, by a well-known triangular wave PWM process. That is, a PWM signal g [symbol] is generated on the basis of the difference between a carrier signal having a triangular wave form and a Duty signal D [symbol] ( [symbol] =u, v, w) obtained by normalizing three-phase command voltages vu*, vv*, vw*, which are operation amounts, with input voltages (power supply voltage VDC) of the inverters INVa, INVb, INVc. On the basis of the PWM signal g [symbol] and a logic inversion signal thereof, an operation signal g [symbol] # is generated through a dead time addition process.

In the present embodiment, respective frequencies of carrier signals (carrier frequencies) are set by the conversion microcomputers 34a, 34b, 34c so as to be different from each other. This setting is performed to decrease the root-mean-square value of a ripple current flowing through the smoothing capacitor 18. That is, due to the carrier frequencies different from each other, the root-mean-square value of the sum of the ripple currents due to respective switching operations of the inverters INVa, INVb, INVc becomes smaller than the sum of the root-mean-square values of the ripple currents depending on switching operations of the inverters INVa, INVb, INVc. Hence, the shared smoothing capacitor 18 provides advantages such as miniaturization of the smoothing capacitor 18, compared with the case in which smoothing capacitors are individually provided for the inverters INVa, INVb, INVc.

Specifically, as shown in FIG. 3A, as the number of the inverters increase, the effect of the decrease of the root-mean-square value of the sum of the ripple currents due to respective switching operations of the inverters is enhanced, compared with that of the sum of the root-mean-square values of the ripple currents depending on switching operations of the inverters. According to the example shown in FIG. 3A, some assumptions are made to simplify calculations. FIG. 3A shows that the root-mean-square value of the sum depending on the number of inverters N can be √N times larger than the root-mean-square value of the sum in the case where the number is one. The derivation of the above relationship is described later.

Even if carrier frequencies used in the respective conversion microcomputers 34a, 34b, 34c are set so as to be different from each other, actual carrier frequencies can unintentionally agree with each other due to individual differences between the conversion microcomputers 34a, 34b, 34c. In this case, for example, as shown in FIG. 3B in which the number of inverters is two, the root-mean-square value of the sum of the ripple currents becomes equal to the sum of the root-mean-square values (in FIG. 3B, the ratio of root-mean-square values is 1), or the ratio of the root-mean-square value of the sum to the sum of the root-mean-square values (the ratio of root-mean-square values) becomes 0.

The ratio of root-mean-square values 0 means that the root-mean-square value of a ripple current of the current flowing through the smoothing capacitor 18 becomes 0 by sharing the smoothing capacitor 18 between two inverters. Although this is the most preferable situation, to realize the situation, it is required that the carrier frequencies agree with each other, and that the phase difference between the carrier frequencies is set to a specific relationship, which is difficult to arrange regardless of individual differences and secular changes.

Hence, it is considered that making the carrier frequencies different from each other is a simple method which can decrease the root-mean-square value of the sum of the ripple currents due to respective switching operations of the inverters INVa, INVb, INVc. However, in this case, it is required to sufficiently separate the carrier frequencies from each other so that the carrier frequencies do not agree with each other regardless of individual differences between the conversion microcomputers 34a, 34b, 34c. This becomes a factor causing a new problem described below.

That is, if a carrier frequency band overlaps with the audible frequency band due to expansion of the used carrier frequency band, noise is generated which can be sensed by a user. In addition, if a high-frequency band of the carrier frequency band becomes excessively high in frequency, switching frequency of the inverter increases, which can increases the loss. These problems become larger as the number of the in-vehicle auxiliary units increases.

To solve these problems, in the present embodiment, a spread spectrum process is performed which varies respective carrier frequencies used in the conversion microcomputers 34a, 34b, 34c.

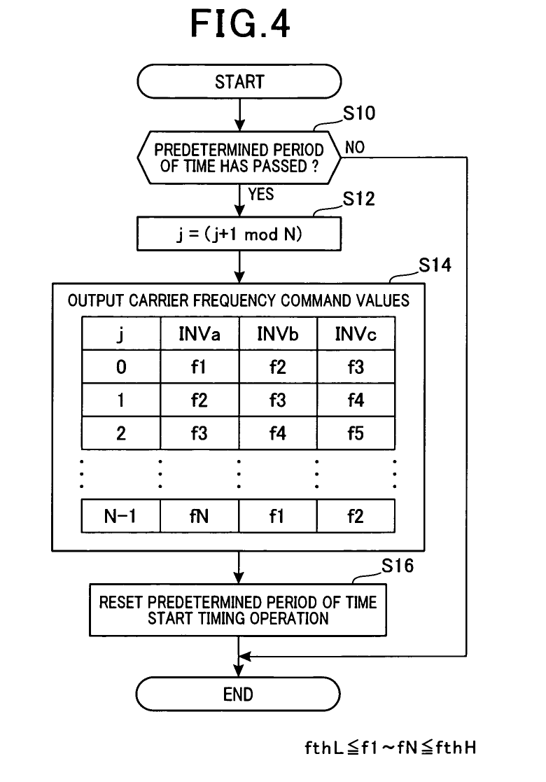

FIG. 4 shows a procedure of the spread spectrum process. This process is repeatedly performed by the communication microcomputer 32, for example, at a predetermined period.

In a series of processes, first in step S10, it is determined whether or not a predetermined period of time has passed. The predetermined period of time has a predetermined time length for fixing a carrier frequency. The time length is set so that the amount of heat generation of the smoothing capacitor 18 does not significantly increase when the root-mean-square value of the sum of the ripple currents increases, even if the respective carrier frequencies used in the conversion microcomputers 34a, 34b, 34c overlap with each other in practice.

If it is determined that the predetermined period of time has passed, it is determined to be the timing when the carrier frequency is changed. The process proceeds to step S12. In step S12, a designated variable j for patterns of the respective carrier frequencies for the inverters INVa, INVb, INVc is updated. In this case, the designated variable j is updated so as to be in order of integers 0 to N−1 which correspond to the number of patterns N.

Next, in step S14, carrier frequency command values designated by the designated variable j are outputted to the respective conversion microcomputers 34a, 34b, 34c. Specifically, in the present embodiment, a map defining the relationship between the designated variables j and the command values f1 to fN of the carrier frequencies, which are different from each other, are used to perform map-calculation for the command values of the carrier frequencies for the respective inverters INVa, INVb, INVc on the basis of the value of the designated variable j. The calculated command values are outputted. As shown in FIG. 4, according to the map, if the designated variable j is 0, the command value of the carrier frequency for the inverter INVa is set to f1, the command value of the carrier frequency for the inverter INVb is set to f2, and the command value of the carrier frequency for the inverter INVc is set to f3. If the designated variable j is 1, the command value of the carrier frequency for the inverter INVa is set to f2, the command value of the carrier frequency for the inverter INVb is set to f3, and the command value of the carrier frequency for the inverter INVc is set to f4. In this manner, the command values of the carrier frequencies for the inverters INVa, INVb, INc are set so as to be different from each other when any designated variable j is used.

The command values f1 to fN are set so as to be equal to or more than a lower limit frequency fthL and equal to or less than an upper limit frequency fthH. The lower limit frequency fth (e.g. 15 kHz) is set so as to be higher than the maximum audible frequency which is easily sensed by an average person. In addition, the upper limit frequency fthH is set to an upper limit value at which the loss of the inverters INVa, INVb, INVc does not become excessively high.

If the process in step S14 is completed, in step S16, the predetermined period of time is reset, and a timing operation is started for duration time of a carrier frequency updated in step S14.

Note that if the process in the step S16 is completed, or a negative judgment is made in step S10, the overall process is ended.

According to the present embodiment described above, the following advantages can be obtained.

(1) Carrier frequencies are set so as to be different from each other for the inverters INVa, INVb, INVc. In addition, the carrier frequencies are varied. Hence, even when the frequency difference between two of the command values f1 to fN is small so that actual carrier frequencies can agree with each other due to the individual difference between the conversion microcomputers 34a, 34b, 34c, the root-mean-square value of the sum of the ripple currents due to respective switching operations of the inverters INVa, INVb, INVc can be decreased.

For example, a case is considered in which actual carrier frequencies of the respective conversion microcomputers 34a, 34b agree with each other during a period of time, during which the conversion microcomputers 34a follows the command value f1, and the conversion microcomputers 34b follows the command value f2. In this case, the probability is low that actual carrier frequencies of the respective conversion microcomputers 34b, 34c agree with each other during a period of time, during which the conversion microcomputers 34b follows the command value f1, and the conversion microcomputers 34c follows the command value f2. In addition, the probability is also low that actual carrier frequencies of the respective conversion microcomputers 34a, 34b agree with each other during a period of time, during which the conversion microcomputers 34a follows the command value f2, and the conversion microcomputers 34b follows the command value f3.

As described above, varying carrier frequencies can sufficiently lower the possibility that a state continues in which the carrier frequencies agree with each other, even if the carrier frequencies temporarily agree with each other. Hence, concerning the sum of the ripple currents due to switching operations of the respective inverters INVa, INVb, INVc, the root-mean-square value per a period of time, during which the temperature of the smoothing capacitor 18 can significantly increase, can be sufficiently approximated in practice to the root-mean-square value obtained when the carrier frequencies are always different from each other.

In addition, when the differences between the carrier frequencies are set to be larger so that actual carrier frequencies do not agree with each other regardless of the individual differences, the difference between the minimum value and the maximum value of the carrier frequencies becomes larger. Thereby, for example, the maximum frequency easily becomes excessively large. However, even in this case, by performing a spread spectrum process, switching loss of each of the inverters per unit of time can be reduced, compared with the case in which the carrier frequency of a specific inverter is fixed to the maximum frequency.

(2) The communication microcomputer 32 outputs the command values of carrier frequencies to the respective conversion microcomputers 34a, 34b, 34c. Hence, a situation in which the carrier frequencies to be set agree with each other can always be suitably avoided without obtaining carrier frequency information of each of the conversion microcomputers 34a, 34b, 34c by communicating between the conversion microcomputers 34a, 34b, 34c.

(3) The carrier frequencies are varied according to a periodical pattern. Hence, the load of calculation of the spread spectrum process can be reduced, while the design of the spread spectrum process can be simplified.

(4) The command values f1 to fN are set so as to be larger than audible frequencies. Hence, a situation can be suitably avoided in which noise is generated which can be sensed by a person depending on switching operations of the inverters INVa, INVb, INVc.

(5) The command values f1 to fN are varied in a range equal to or less than an upper limit frequency fthH. Hence a situation can be suitably avoided in which switching loss excessively increases.

### Second Embodiment

Hereinafter, the second embodiment is described focusing on differences from the first embodiment.

In the present embodiment, each of the conversion microcomputers 34a, 34b, 34c stores a change pattern of carrier frequencies, and performs a spread spectrum process on the basis of the change pattern.

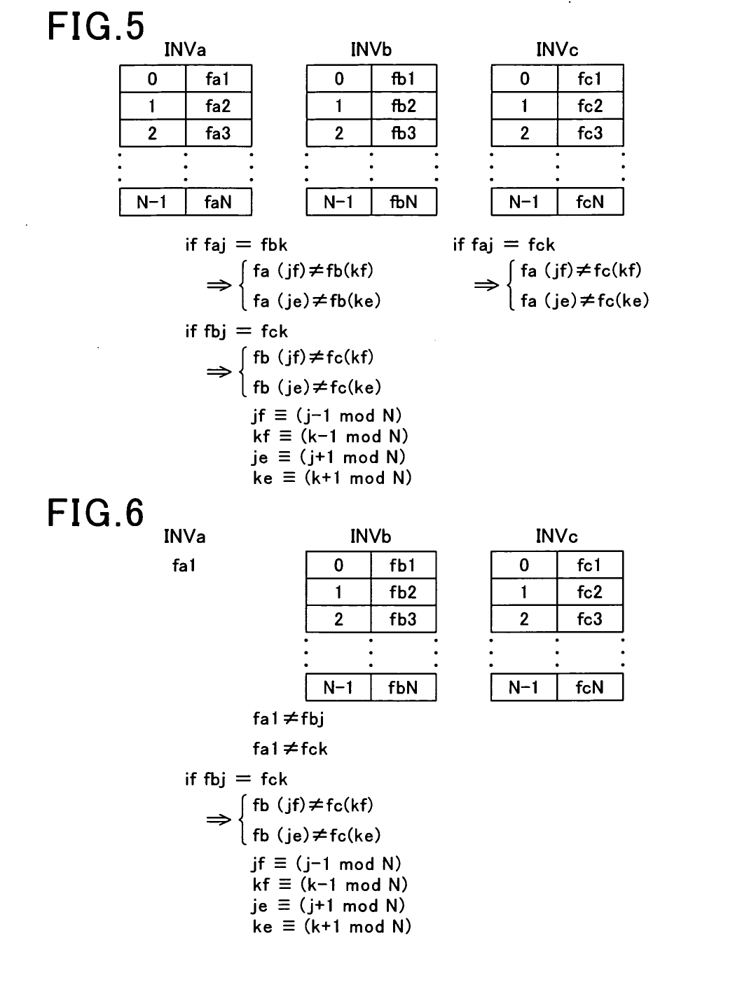

FIG. 5 shows a map of change patterns stored in the respective conversion microcomputers 34a, 34b, 34e. As shown in FIG. 5, all the patterns stored in the respective conversion microcomputers 34a, 34b, 34c use carrier frequencies the number of which is N. N of the carrier frequencies are the same between the conversion microcomputers 34a, 34b, 34c. Note that the N carrier frequencies are arranged so that the arrangements thereof differ from each other between the conversion microcomputers 34a, 34b, 34c. Specifically, when a carrier frequency faj (j=1 to N) of the conversion microcomputer 34a agrees with a carrier frequency fbk (k=1 to N) of the conversion microcomputer 34b, the carrier frequencies before the carrier frequency faj and the carrier frequency fbk are different from each other, and the carrier frequencies after the carrier frequency faj and the carrier frequency fbk are different from each other. That is, a carrier frequency fa(jk) and a carrier frequency fb(kf) before the carrier frequency faj and the carrier frequency fbk are different from each other (jf=j−1 mod N, kf=k−1 mod N). A carrier frequency fa(je) and a carrier frequency fb(ke) after the carrier frequency faj and the carrier frequency fbk are different from each other (je=j+1 mod N, ke=k+1 mod N).

Similarly, when a carrier frequency faj (j=1 to N) of the conversion microcomputer 34a agrees with a carrier frequency fck (k=1 to N) of the conversion microcomputer 34c, the carrier frequencies before the carrier frequency faj and the carrier frequency fek are different from each other, and the carrier frequencies after the carrier frequency faj and the carrier frequency fck are different from each other. In addition, when a carrier frequency fbj (j=1 to N) of the conversion microcomputer 34b agrees with a carrier frequency fck (k=1 to N) of the conversion microcomputer 34c, the carrier frequencies before the carrier frequency fbj and the carrier frequency fck are different from each other, and the carrier frequencies after the carrier frequency fbj and the carrier frequency fck are different from each other.

According to the above setting, even when each of the conversion microcomputers 34a, 34b, 34c does not recognize carrier frequencies of the others, a situation in which the carrier frequencies to be set continue to agree with each other can be suitably avoided.

### Third Embodiment

Hereinafter, the third embodiment is described focusing on differences from the second embodiment.

In the present embodiment, the carrier frequency of the inverter INVa is fixed to a frequency fa1. A spread spectrum process of carrier frequencies is performed only for the inverters INVb, INVc. FIG. 6 shows a carrier frequency stored in the conversion microcomputer 34a, and a map of change patterns stored in the respective conversion microcomputers 34b, 34c.

As shown in FIG. 6, all the patterns stored in the respective conversion microcomputers 34b, 34c use N carrier frequencies. N of the carrier frequencies are the same between the conversion microcomputers 34b, 34c. Note that the N carrier frequencies are arranged so that the arrangements thereof differ from each other between the conversion microcomputers 34b, 34c. Specifically, when a carrier frequency fbj (j=1 to N) of the conversion microcomputer 34b agrees with a carrier frequency fck (k=1 to N) of the conversion microcomputer 34c, the carrier frequencies before the carrier frequency fbj and the carrier frequency fck are different from each other, and the carrier frequencies after the carrier frequency fbj and the carrier frequency fck are different from each other.

Meanwhile, the conversion microcomputer 34a uses a single carrier frequency fa1, which differs from any of the carrier frequencies fb1 to fbN, fc1 to fcN used in the respective inverters INVb, INVc.

According to the above setting, for example, the load of calculation of the conversion microcomputer 34a can be reduced. In addition, when heat generation from the conversion microcomputer 34a becomes a great problem, the carrier frequency fa1 can be smaller than an average value of the carrier frequencies fb1 to fcN set by the spread spectrum process. Thereby, the carrier frequencies (average value thereof) used by the conversion microcomputer 34a can easily be smaller than the average value of the carrier frequencies used by the conversion microcomputers 34b, 34c.

### Other Embodiments

Regarding the operation means (section):

The carrier signal used in the PWM process may not be a triangular wave, but be a saw tooth wave.

The operation means is not limited to the configuration in which an operation signal is generated by a comparison process using a carrier signal. For example, the operation means may perform instantaneous current value control disclosed in JP-A-2009-153254. In JP-A-2009-153254, a process is performed in which a switching state is changed when the difference between an actual current and a command current falls outside an acceptable range. In addition, the switching state is changed if a specific condition is met, thereby aiming at a switching pattern similar to that of the triangular wave so PWM process. Hence, it is considered that, by setting the acceptable range of this method, the same advantage can be obtained as that of a case when a carrier frequency is varied in the triangular wave PWM process. In other words, it can be considered that, by setting the acceptable range, the switching frequencies of the inverters INVa, INVb, INVc can be different from each other.

The operation means is not limited to a configuration providing respective operation portions for power conversion circuits. When providing a single operation means (conversion microcomputer) common to the plurality of power conversion circuits, the carrier frequencies of the respective power conversion circuits can be easily set to not accidentally agree with each other as in the case of the first embodiment.

Regarding the Command Means (Section):

In the above embodiment, the communication microcomputer 32 outputs command values of carrier frequencies to the respective conversion microcomputers 34a, 34b, 34c via respective signal lines. However, the command means is not limited to this configuration. For example, by adding data specifying the inverters corresponding to the respective command values, the command values can be outputted to all the conversion microcomputers 34a, 34b, 34c via a single signal line.

Regarding the Variation Means (Section):

In the above embodiment, the number of candidates for carrier frequencies to be varied (carrier frequencies subject to variable setting) is set to be larger than the number of the inverters. However, the number of candidates may be equal to the number of the inverters. Even when the differences between the carrier frequencies are set so as to be included within a range of variation which can be caused, it is considered that the root-mean-square value of the sum of the ripple currents due to the inverters INVa, INVb, INVc becomes smaller, compared with a case in which the carrier frequencies of the inverters INVa, INVb, INVc are fixed. This is because, if the carrier frequencies f1, f2, f3 of the respective inverters INVa, INVb, INVc are fixed, the actual carrier frequencies of the inverters INVa, INVb can agree with each other due to, for example, individual differences between the conversion microcomputer 34a and 34b. This situation is considered to continue. If a spread spectrum process is performed using only three frequencies f1, f2, f3, and even if the respective conversion microcomputers 34a, 34b use the carrier frequencies f1, f2 due to, for example, an individual difference between the conversion microcomputer 34a and 34b, whereby actual carrier frequencies agree with each other, it can be considered that the probability that the actual frequencies agree with each other is not so high when the conversion microcomputer 34a uses the carrier frequency f3, the conversion microcomputer 34c uses the carrier frequency f2, and the conversion microcomputer 34b uses the carrier frequency f1.

In the variation means which periodically varies carrier frequencies according to predetermined patterns, all the periods of time during which the carrier frequencies are fixed are not limited to be the same. For example, in the first embodiment, if predetermined periods of time are varied during which carrier frequencies are fixed depending on the designated variable j, average values of the carrier frequencies can be different from each other in the inverters INVa, INVb, INVc.

The variation means is not limited to the configuration in which carrier frequencies are periodically varied according to predetermined patterns. The carrier frequencies may be appropriately selected according to parameters varied depending on the probability, for example, an ambient noise level.

Regarding the Capacitors:

The capacitors 18a, 18b, which are different types from each other, are not limited to an aluminum electrolytic capacitor and a ceramic capacitor. For example, three or more types of capacitors may be used in combination. Alternatively, only one type of capacitor can be used.

All the capacitors are not necessarily required to be mounted on the power supply board 50p. For example, part of the capacitors may be connected to an input terminal of the inverter INVa on the conversion board 50a, may be connected to an input terminal of the inverter INVb on the conversion board 50b, and may be connected to an input terminal of the inverter INVc on the conversion board 50c. Hence, parasitic inductance can be lower by which the amount of the current varies when switching states of the inverters INVa, INVb, INVc are changed, thereby decreasing surge. Note that the capacitors mounted on the conversion boards 50a, 50b, 50c have functions for suppressing variations in input voltages of the inverters INVa, INVb, INVc. Hence, in this case, the cooperation between the respective capacitors mounted on the power supply board 50p and the conversion boards 50a, 50b, 50c can reduce the variations of the input voltages. However, even in this case, mounting a capacitor common to the inverters INVa, INVb, INVc can obtain the advantages according to those of the above embodiment.

Regarding the Power Supply Board:

The power supply board may not be provided with only the communication microcomputer 32, but may be provided with the conversion microcomputers 34a, 34b, 34c.

Regarding Arrangement of the Auxiliary Units and the Power Conversion Circuits:

In the above embodiment, auxiliary units are provided outside the case. However, any one of a plurality of in-vehicle auxiliary units, the power supply board 50p, and the conversion boards 50a, 50b, 50c may be accommodated in one case.

Regarding the Conversion Board:

The number of the conversion boards accommodated in one case is not limited to three, but may be two, four or more. In addition, inverters corresponding to respective in-vehicle auxiliary units different from each other may be formed on one conversion board.

Regarding the Insulation Communication Means (Section):

The insulation communication means is not limited to a light insulation element such as the photocoupler 30, but may be a magnetic insulation element.

Regarding the Power Conversion Circuit:

The power conversion circuit is not limited to a three-phase inverter. For example, the heater 24 may be a one-phase inverter. In addition, if a five-phase motor is used as the motor 20 of the blower fan, a five-phase inverter is used.

Note that the power conversion circuit is not limited to a DC-AC conversion circuit including switching elements which selectively connect between the positive electrode and the negative electrode of the source of direct voltage and the terminals of the auxiliary unit.

Other Configurations:

The above power conversion apparatus may be applied not only to the hybrid vehicle but also to a configuration which includes only a means for outputting electrical energy (secondary battery, fuel battery) as a means for storing energy supplied to the in-vehicle traction unit. Even in this case, when a power supply of a plurality of in-vehicle auxiliary units such as a blower fan and a heater is used as the storing means, the above power conversion apparatus can be effectively applied.

The power supply is not limited to a power supply for an in-vehicle traction unit.

A rotation angle detection means (section) may be provided which detects an angle of rotation of a rotating machine.

The case is not limited to a single case. For example, a configuration may be provided which has separate cases which include a case accommodating the power supply board 50p, a case accommodating the conversion board 50a, a case accommodating the conversion board 50b, and a case accommodating the conversion board 50c, and a means (section) for connecting the cases to each other at side surfaces thereof.

Remarks:

Hereinafter, a quantitative explanation is provided for the fact that the root-mean-square value of the sum of the ripple currents can be decreased by making a difference between the switching frequencies of a plurality of inverters.

To simplify the explanation, a case is explained in which two inverters, an inverter INV1 and an inverter INV2, are provided. In addition, a ripple current I1 of the inverter INV1 and a ripple current I2 of the inverter INV2 are modeled by the following expressions, using angular velocities ω1, ω2 depending on the switching frequencies.

I1=A1×sin(ω1×t−θ1) (c1)

I2=A2×sin(ω2×t−θ2) (c2)

The root-mean-square value Irms of the sum of the ripple current I1 and the ripple current I2 is expressed as the following expression (c3) when using time T.

$$\begin{matrix}Irms = \sqrt{\frac{1}{T} {\int }_{0}^{T} {( I 1 + I 2 )}^{2} d t} \\ = \sqrt{\begin{matrix}\frac{1}{T} {\int }_{0}^{T} ( I {1}^{2} + I {2}^{2} ) d t + \frac{2 A 1 A 2}{T} {\int }_{0}^{T} sin ( ω 1 \cdot t - θ 1 ) \cdot \\ sin ( ω 2 \cdot t - θ 2 ) d t\end{matrix}}\end{matrix} \qquad ( c 3 )$$

The second term in the square root of the right side of the expression (c3) can be modified to the following expression (c4).

$$\frac{A 1 A 2}{T} {\int }_{0}^{T} [ cos \{ ( ω 1 - ω 2 ) t + ( θ 1 - θ 1 ) \} - cos \{ ( ω 1 + ω 2 ) t + ( θ 1 + θ 1 ) \} ] d t \qquad ( c4 )$$

If ω1≠ω2, the above expression (c4) converges on 0 as the time T lengthens. Hence, the root-mean-square value Irms is expressed as the following expression (c5).

$$Irms = \sqrt{\frac{A {1}^{2} + A {2}^{2}}{2}} \qquad ( c5 )$$

Meanwhile, the respective root-mean-square values I1rms, I2rms of the ripple currents I1, I2 of the inverter INV1 and the inverter INV2 are expressed by the following expressions (c6), (c7) where time T is a common multiple of periods corresponding the angular velocities ω1, ω2.

$$\begin{matrix}I 1 r m s = \sqrt{\frac{1}{T} {\int }_{0}^{T} I {1}^{2} d t} = \frac{A 1}{\sqrt{2}} & ( c6 ) \\ I 2 r m s = \sqrt{\frac{1}{T} {\int }_{0}^{T} I {2}^{2} d t} = \frac{A 2}{\sqrt{2}} & ( c 7 )\end{matrix}$$

Here, for simplicity, assuming that the amplitudes A1, A2 of the ripple currents I1, I2 are equal to each other, “Irms/(I1rms+I2rms)” is “1/√2”. Note that, according to an inductive discussion, when the number of the inverters is N (>3), the ratio of the root-mean-square value of the sum of the ripple currents to the sum of the respective root-mean-square values of the ripple currents is “1/√N”.

Note that, in the expression (c4), if “ω1=ω2”, “θ1−θ2=π”, and “A1=A2”, the root-mean-square value Irms of the sum of the ripple currents is 0. This is the reason why the ratio of the root-mean-square values becomes 0 in FIG. 3B. Note that when modeling the ripple currents into square waves instead of calculating the ripple currents by the expressions (c1), (c2), harmonic components are required to be additionally considered using a Fourier transform. However, even if the components are added, the result is not changed.

Hereinafter, aspects of the above-described embodiments will be summarized.

As an aspect of the embodiment, a power conversion apparatus is provided which includes: a plurality of power conversion circuits which individually supply power to a plurality of in-vehicle auxiliary units; a common capacitor which is connected to input terminals of the plurality of power conversion circuits; an operation section which operates respective switching elements of the plurality of power conversion circuits; and a variation section which varies a switching frequency of the switching element configuring at least one of the power conversion circuits, when the operation section turns on or off the switching element. The operation section sets switching frequencies of the switching elements of at least two of the power conversion circuits so as to be different from each other.

Under a situation in which a capacitor is shared between a plurality of power conversion circuits, when switching frequencies of the power conversion circuits are different from each other, the root-mean-square value of the sum of the ripple currents due to respective switching operations of the power conversion circuits can be smaller than the sum of the root-mean-square values of the ripple currents. Then if the root-mean-square value of the ripple currents is smaller, the shared capacitor can be miniaturized, and the number of separated parts of one type of capacitor can be decreased.

Note that even if the switching frequencies are set so as to be different from each other, actual switching frequencies can unintentionally agree with each other due to the error of the operation section or the like. To avoid such a situation, it can be considered to enlarge the difference between the frequencies to be different from each other, and to use an operation section having high precision. Note that, in the former case, the switching frequency band to be used can be excessively widened. In the latter case, the selection of the operation section can be restricted.

To solve these problems, by providing the variation section, a situation can be suitably avoided in which switching frequencies unintentionally agree with each other. Thereby, a situation can be avoided in which the root-mean-square value of a specific frequency component of the ripple current becomes excessively large.

In the power conversion apparatus, the operation section generates an operation signal of the switching element on the basis of the difference between a command value of an output voltage of the power conversion circuit and a carrier signal whose carrier frequency has been set. The variation section varies the set carrier frequency.

It has been found out that the frequency of the ripple current varies depending on the carrier frequency. Hence, by varying the carrier frequency, a situation can be suitably avoided in which the root-mean-square value of a specific frequency component of the ripple current becomes excessively large.

In the power conversion apparatus, the operation section includes operation units individually provided for the power conversion circuits which are objects to be operated. The variation section outputs command values of the carrier frequencies to the operation units.

According to the apparatus, by providing a means for outputting command values, a situation in which the carrier frequencies to be set (command values of the carrier frequencies) agree with each other can be suitably avoided without obtaining each carrier frequency information by communicating between the operation units.

In the power conversion apparatus, the operation section includes operation units individually provided for the power conversion circuits which are objects to be operated. The variation section is included in the operation unit and varies the carrier frequency in a random manner.

According to the above apparatus, since the operation unit includes a means for changing the carrier frequency in a random manner, a situation in which actual values of the carrier frequencies to be set agree with each other can be suitably avoided without obtaining each carrier frequency information by communicating between the operation units.

In the power conversion apparatus, the variation section varies the carrier frequency on the basis of a periodical pattern.

According to the above embodiment, by using a periodical pattern, the load of calculation of the variation section can be reduced, while the design of the variation section can be simplified.

In the power conversion apparatus, the variation section varies the carrier frequencies concerning the respective power conversion circuits.

In the power conversion apparatus, the variation section fixes the carrier frequency concerning the power conversion circuit corresponding to a specific in-vehicle auxiliary unit of the plurality of in-vehicle auxiliary units.

According to the above embodiment, since the carrier frequency concerning the specific power conversion circuit can be fixed, a frequency is easily set according to requirement factors other than the requirement for reducing the root-mean-square value of the ripple current, for the specific power conversion circuit.

In the power conversion apparatus, the variation section makes the carrier frequency higher than audible frequencies.

According to the apparatus, a situation can be suitably avoided in which noise is generated which can be sensed by a person due to switching operations of the power conversion circuits.

In the power conversion apparatus, the variation section varies the carrier frequency in a range equal to or less than an upper limit value.

In the power conversion apparatus, by defining the upper limit value, a situation can be suitably avoided in which switching loss excessively increases.

It will be appreciated that the present invention is not limited to the configurations described above, but any and all modifications, variations or equivalents, which may occur to those who are skilled in the art, should be considered to fall within the scope of the present invention.

What is claimed is:

1. A power conversion apparatus, comprising:
a plurality of power conversion circuits which individually supply power to a plurality of in-vehicle auxiliary units;
a common capacitor which is connected to input terminals of the plurality of power conversion circuits;
an operation section which operates respective switching elements of the plurality of power conversion circuits; and
a variation section which varies a switching frequency of the switching element configuring at least one of the power conversion circuits, when the operation section turns the switching element on or off; wherein
the operation section sets switching frequencies of the switching elements of at least two of the power conversion circuits so as to be different from each other.

2. The power conversion apparatus according to claim 1, wherein
the operation section generates an operation signal of the switching element on the basis of the difference between a command value of an output voltage of the power conversion circuit and a carrier signal whose carrier frequency has been set, and
the variation section varies the set carrier frequency.

3. The power conversion apparatus according to claim 2, wherein
the operation section comprises operation units individually provided for the power conversion circuits which are objects to be operated, and
the variation section outputs command values of the carrier frequencies to the operation units.

4. The power conversion apparatus according to claim 2, wherein
the operation section comprises operation units individually provided for the power conversion circuits which are objects to be operated, and
the variation section is included in the operation unit and varies the carrier frequency in a random manner.

5. The power conversion apparatus according to claim 2, wherein
the variation section varies the carrier frequency on the basis of a periodical pattern.

6. The power conversion apparatus according to claim 2, wherein
the variation section varies the carrier frequencies concerning the respective power conversion circuits.

7. The power conversion apparatus according to claim 2, wherein
the variation section fixes the carrier frequency concerning the power conversion circuit corresponding to a specific in-vehicle auxiliary unit of the plurality of in-vehicle auxiliary units.

8. The power conversion apparatus according to claim 2, wherein
the variation section makes the carrier frequency higher than audible frequencies.

9. The power conversion apparatus according to claim 2, wherein
the variation section varies the carrier frequency in a range equal to or less than an upper limit value.
